(19) United States
(12) Patent Application Publication
(10) Pub. No.: US 2006/0216636 A1
(43) Pub. Date: Sep. 28, 2006

(54) Catalytic resist including metal precursor compound and method of patterning catalyst particles using the same

(75) Inventors: Yo-sep Min, Yongin-si (KR); Eun-ju Bae, Yongin-si (KR); Wan-Jun Park, Seoul (KR)

Correspondence Address: BUCHANAN, INGERSOLL & ROONEY PC, POST OFFICE BOX 1404, ALEXANDRIA, VA, 22313-1404, US

(73) Assignee: Samsung Electronics Co., Ltd., Suwon-si (KR)

(21) Appl. No.: 11/280,412

(22) Filed: Nov. 17, 2005

(30) Foreign Application Priority Data
Mar. 22, 2005 (KR) 10-2005-0023646

(51) Int. Cl. G03C 1/00

(52) U.S. Cl. 430/270.1

(57) ABSTRACT

A catalytic resist and a method of patterning catalyst particles using the same are provided. The catalytic resist includes a resist and a metal precursor compound uniformly dispersed in the resist.

### CROSS-REFERENCE TO RELATED PATENT APPLICATION

This application claims the benefit of Korean Patent Application No. 10-2005-0023646, filed on Mar. 22, 2005, in the Korean Intellectual Property Office, the disclosure of which is incorporated herein in its entirety by reference.

### BACKGROUND OF THE DISCLOSURE

1. Field of the Disclosure

The present disclosure relates to a catalytic resist including a metal precursor compound and a method of patterning catalyst particles using the same.

2. Description of the Related Art

A lithography process is essential for fabricating high-integrated electronic devices. Recently, the wavelength of light employed in the lithography process has become gradually shorter so as to form a pattern having thinner line widths. A lithography process using an electron beam is also applied to fabricate nano-scale devices.

In a process of fabricating a highly integrated electronic device, metal catalysts or seeds are used. For example, metal catalysts are used for crystallizing amorphous silicon into polysilicon, platinum (Pt) catalysts are used for activating crystallization of a ferroelectrics thin film, catalysts are used for growing carbon nanotubes (CNTs), or seeds are used for plating in a cupper metallization process. In order to make a device using such catalysts or seeds, catalysts or seeds are formed, and then the formed catalysts or seeds must be placed only at selected sites by patterning in a lithography process.

However, in those instances where an unetchable metal is used for the catalysts or seeds, it is impossible to place the catalysts or seeds exclusively at the desired sites by a conventional lithography process. In addition, in those instances where the catalysts or seeds are not thin films but nano particles, the process is even more complicated. For example, for a site-selective deposition of catalyst particles for CNT growth, a dispersion solution of Fe/Mo catalyst particles using alumina supporters is coated onto the surface of a substrate, and then a resist is coated thereon for use when performing subsequent processes of exposure, development and lift-up. However, these processes cannot be readily applied over a large area to uniformly deposit catalyst particles.

### SUMMARY OF THE DISCLOSURE

The present invention may provide a method of depositing catalyst particles at selected sites using a catalytic resist, that is, a dispersion solution of a metal precursor compound in an existing resist.

A catalytic resist according to an aspect of the present invention includes a resist and a metal precursor compound uniformly dispersed in the resist.

The metal precursor compound may be an organic metal compound chemically unreactive with the resist and insoluble in water. The organic metal compound may include at least one metal selected from the group consisting of Fe, Co, Cu, Ni, Cr, Mo, Pt, Pd, Rh, Au, and Ag.

The resist may include a photoresist and an electron beam (e-beam) resist. Here, the photoresist may include photoactive compounds, a polymer resin and a solvent. In addition, the e-beam resist may include a polymer such as polymethyl methacrylate (PMMA) and a solvent.

A method of patterning catalyst particles using a catalytic resist according to another aspect of the present invention includes: applying a catalytic resist including a resist and a metal precursor compound uniformly dispersed in the resist on a substrate; forming a catalytic resist pattern by patterning the catalytic resist in a predetermined shape; and depositing catalyst particles at predetermined sites by removing organic substances from the catalytic resist pattern.

A predetermined substance layer may be formed on the substrate. In this embodiment, after forming the catalytic resist pattern, the substance layer may be further etched at a predetermined depth with the catalytic resist pattern as an etching mask.

The catalytic resist may be applied on the substrate by a spin coating method.

The process of patterning the catalytic resist includes: exposing the catalytic resist applied to the substrate via a predetermined patterned mask; and developing the catalytic resist exposed in the predetermined pattern.

The deposition of the catalyst particles can be realized by burning or plasma ashing the catalytic resist pattern under an oxidizing atmosphere.

### BRIEF DESCRIPTION OF THE DRAWINGS

The above and other features and advantages of the present invention are described in detail exemplary embodiments thereof with reference to the attached drawings in which:

FIGS. 1A through 1F are schematic views illustrating a method of patterning catalyst particles by using a catalytic resist according to an embodiment of the present invention;

FIGS. 2A through 2C are schematic views illustrating a method of patterning catalyst particles by using a catalytic resist according to another embodiment of the present invention;

FIG. 3 shows nuclear magnetic resonance (NMR) spectrums of a catalytic resist having iron (Fe) catalysts according to an embodiment of the present invention;

FIG. 4A is an optical microscope image showing a patterned shape of a catalytic resist having a metal precursor compound according to an embodiment of the present invention;

FIG. 4B is an optical microscope image showing carbon nanotubes (CNTs) grown on catalyst particles, obtained from the catalytic resist pattern of FIG. 4A, by a chemical vapor deposition (CVD) method;

FIGS. 5A and 5B are scanning electron microscope (SEM) images showing CNT grown and ungrown portions in FIG. 4B, respectively;

FIGS. 6A and 6B are SEM images showing CNTs, when using a catalytic resist pattern as an etching mask according to an embodiment of the present invention, the grown catalyst particles obtained from the catalytic resist pattern;

FIG. 7 shows x-ray photoelectron spectroscopy (XPS) spectrums of catalyst particles obtained from a catalytic resist pattern according to an embodiment of the present invention;

FIG. 8 is a thermal analysis data of a catalytic resist according to an embodiment of the present invention, for monitoring weight and calorie changes of the catalytic resist with flowing air; and

FIGS. 9A and 9B are transmission electron microscope (TEM) images showing singlewall CNTs and multiwall CNTs grown by using a catalytic resist according to an embodiment of the present invention.

### DETAILED DESCRIPTION OF THE EXEMPLARY EMBODIMENTS

Hereinafter, exemplary embodiments will be described in detail with reference to the attached drawings. Like reference numerals refer to like elements throughout the drawings.

In the present invention, to deposit catalyst particles for the growth of carbon nanotubes (CNTs) only at selected sites, a catalytic resist, which is a uniform dispersion solution of a metal precursor compound in a resist, is used. A commercially available existing photoresist or electron beam (e-beam) resist may be used as the resist. The photoresist may include photoactive compounds (PAC), a polymer resin, and a solvent. Additionally, the e-beam resist may include a polymer such as polymethyl methacrylate (PMMA) and a solvent.

The metal precursor compound may be an organic metal compound chemically unreactive with the resist and insoluble in water. The organic metal compound may include at least one metal selected from the group consisting of Fe, Co, Cu, Ni, Cr, Mo, Pt, Pd, Rh, Au and Ag.

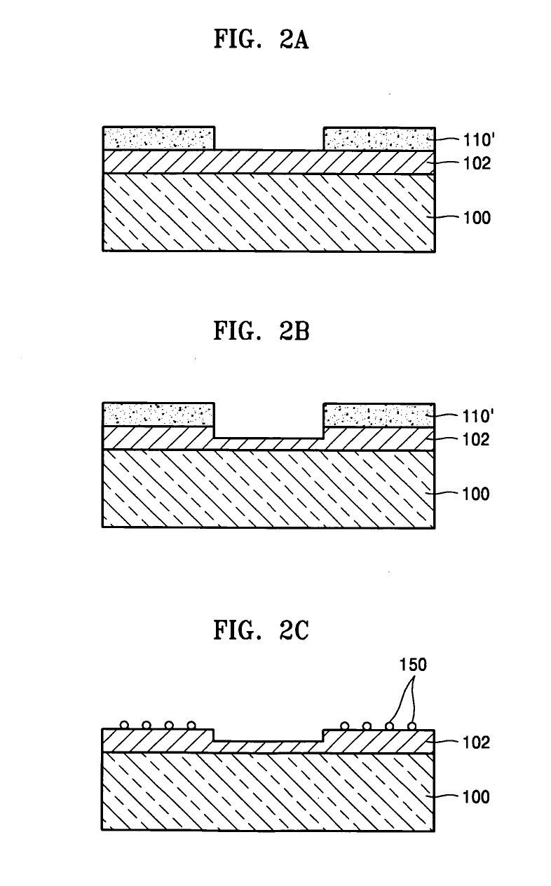

FIG. 3 shows nuclear magnetic resonance (NMR) spectrums of a catalytic resist according to an embodiment of the present invention. In this embodiment, an existing photoresist is used as the resist and a ferrocene of an iron precursor is used as the metal precursor. “A” and “B” in FIG. 3 indicate NMR spectrums of the ferrocene and the photoresist, respectively. Since the ferrocene has ten chemically identical hydrogen atoms, only one peak is shown in the NMR spectrum. “C” and “D” in FIG. 3 show NMR spectrums for analyzing the catalytic resists immediately and 20 days after dispersing the ferrocene into the photoresist, respectively. Since the spectrum for the ferrocene 20 days after dispersing also shows only one peak, no chemical reaction has occurred between the ferrocene and the photoresist. If a chemical reaction between the ferrocene and the photoresist occurs, essential characteristics of the resist could be harmed, and thus no chemical reaction between a metal precursor and a resist used in a catalytic resist should occur. Accordingly, to meet the demand for insolubility in water and chemical unreactivity, the catalytic resist containing the metal precursor compound according to the present invention may include a dispersion solution of an organic metal complex employing a ligand, such as cyclopentadienyl and acetylacetonate, within the resist.

Hereinafter, a method of patterning catalyst particles using a catalytic resist according to an embodiment of the present invention will be described.

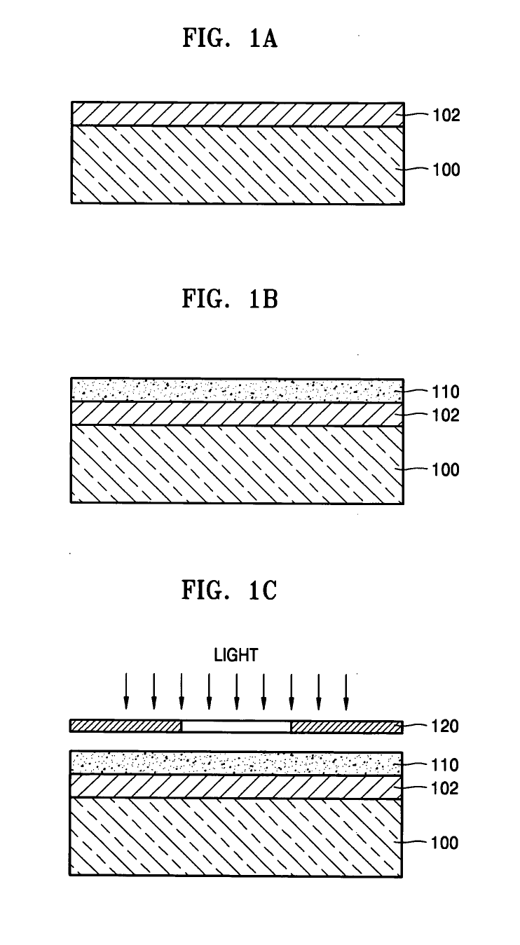

FIGS. 1A through 1F are schematic views illustrating a method of patterning catalyst particles according to an embodiment of the present invention. First of all, referring to FIG. 1A, a substrate 100 is prepared, and a predetermined substance layer 102 is formed on a surface of the substrate 100. A silicon substrate is commonly employed as the substrate 100, and the substance layer 102 may be formed of silicon oxide (SiO₂).

Next, referring to FIG. 1b, a catalytic resist 110 according to an embodiment of the present invention is applied on the surface of the substance layer 102. The catalytic resist 110 may be applied by a spin coating method or other appropriate means. The catalytic resist 110 is a uniform dispersion solution of a metal precursor compound in a resist. The metal precursor compound may be an organic metal compound chemically unreactive with the resist and insoluble in water. In addition, a commercially available photoresist or an e-beam resist may be used as the resist.

Thereafter, referring to FIGS. 1c and 1d, a mask 120 is placed on the upper portion of the catalytic resist 110, and then the catalytic resist 110 is exposed with the mask 120 as a predetermined pattern. The exposed portion 110a (see FIG. 1d) of the catalytic resist 110 is removed with a developing solution, to thereby form a catalytic resist pattern 110′ as shown in FIG. 1e. Although a positive resist, which allows removing of an exposed portion, is used as the resist for the catalytic resist 110, a negative resist may also be used.

Next, the catalytic resist pattern 110′ undergoes burning or plasma ashing to thereby remove organic substances from the catalytic resist pattern 110′, and accordingly deposit catalyst particles 150 at selected sites on the substance layer 102 as shown in FIG. 1e. Therefore, CNTs can grow from the above-described patterned catalyst particles 150.

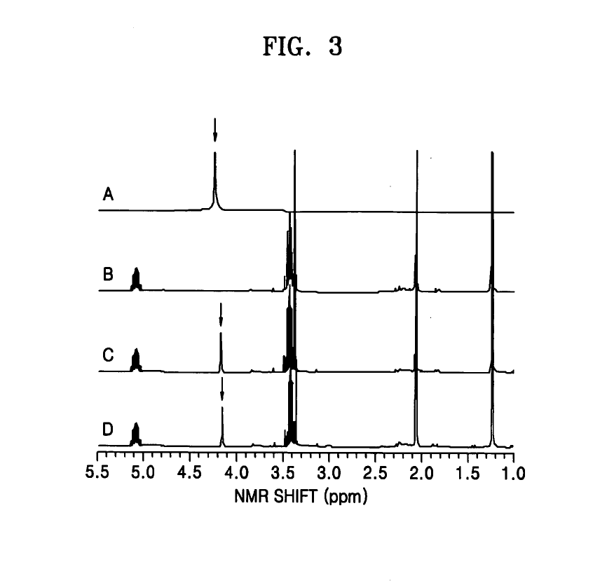

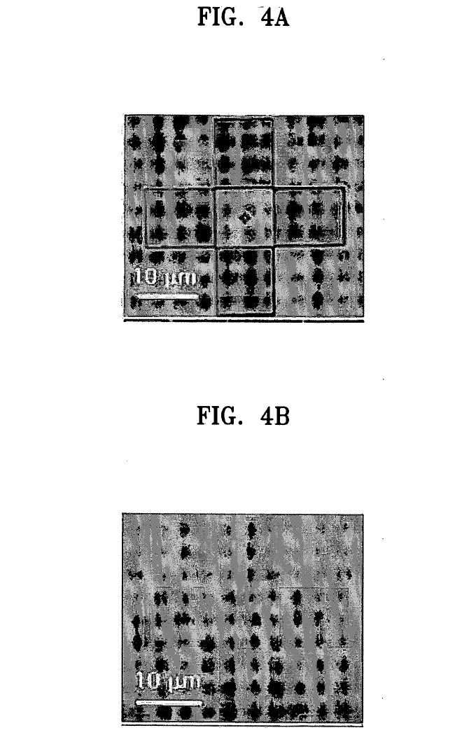

FIG. 4A is an optical microscope image showing a catalytic resist pattern formed by an exposure and development process. FIG. 4B is an optical microscope image showing CNTs grown by a chemical vapor deposition (CVD) on catalyst particles formed by removing organic substances from the catalytic resist pattern. In addition, FIGS. 5A and 5B are scanning electron microscope (SEM) images showing CNT grown and ungrown portions, respectively. Referring to these figures, the CNTs do not grow on the portion where a catalytic resist was removed in the development process because catalyst particles are not deposited thereon, but the CNTs grow from the catalyst particles on the portion where the catalytic resist exists.

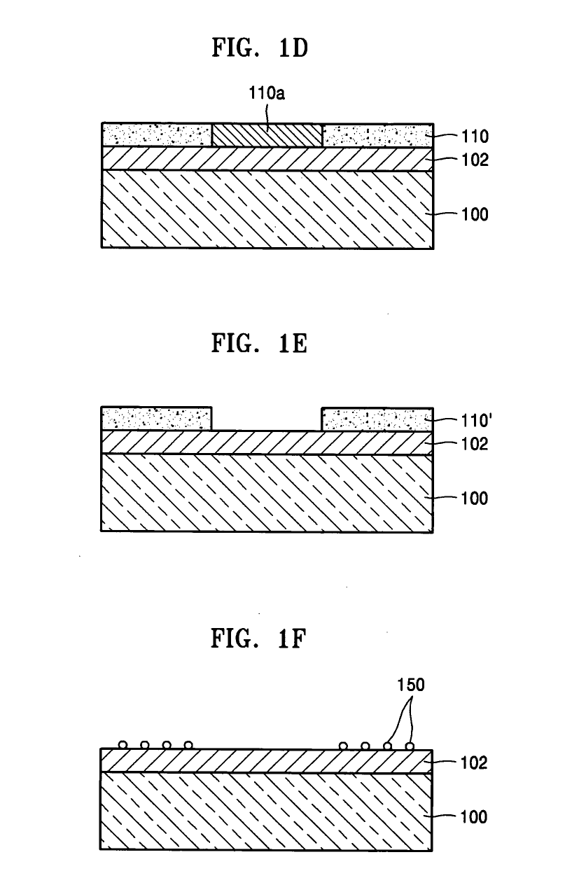

FIGS. 2A through 2C are schematic views illustrating a method of patterning catalyst particles according to another embodiment of the present invention.

Initially, as shown in FIG. 2A, a predetermined substance layer 102 such as silicon oxide (SiO₂) is formed on a surface of a substrate 100 and a catalytic resist pattern 110′ is formed on the top surface of the substance layer 102. The formation of the catalytic resist pattern 110′ has been described above.

Next, as shown in FIG. 2B, the substance layer 102 is etched at a predetermined depth by using the catalytic resist pattern 110′ as an etching mask. Then, the catalytic resist pattern 110′ undergoes burning or plasma ashing to remove organic substances and thereby deposit catalyst particles 150 on the top surface of the patterned substance layer 102, as shown in FIG. 2C.

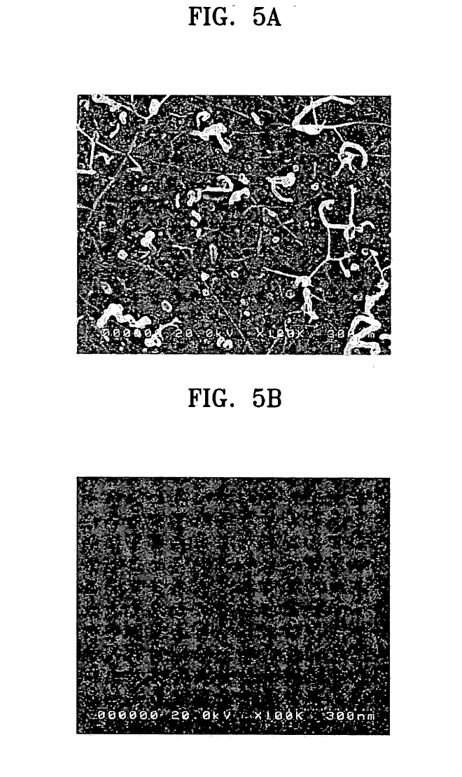

FIGS. 6A and 6B are SEM images showing CNTs grown by CVD on the catalyst particles formed on the top surface of a patterned substance layer. As shown in FIGS. 6A and 6B, the substance layer is patterned by using the catalytic resist pattern according to an embodiment of the present invention as an etching mask, to thereby obtain CNTs suspending on spaces between the patterned substance layers.

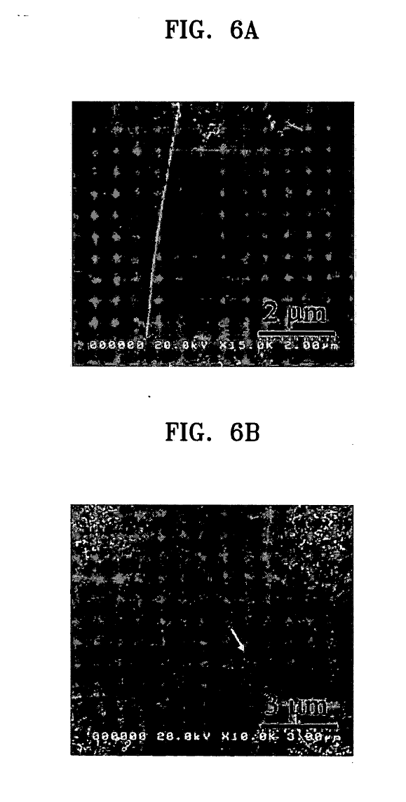

FIG. 7 shows x-ray photoelectron spectroscopy (XPS) spectrums for the deposited portion (“A”) and the undeposited portion (“B”) of catalyst particles after burning a catalytic resist pattern employing a ferrocene, i.e. a precursor of iron. Referring to FIG. 7, peaks of iron (Fe) exist in the deposited portion “A” where the catalyst particles are deposited, while no peak exists in the undeposited portion “B” where the catalytic resist is removed by development that causes the removal of metal precursors.

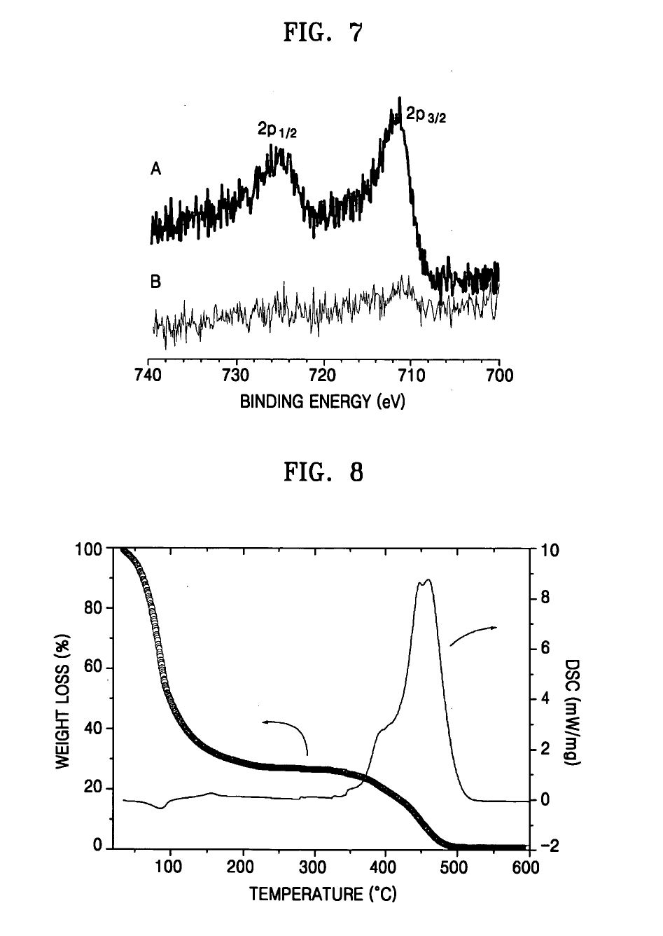

FIG. 8 is thermal analysis data of a catalytic resist according to an embodiment of the present invention, for monitoring weight and calorie changes of the catalytic resist with flowing air. Referring to FIG. 8, the catalytic resist undergoes a weight loss two times. A first weight loss appears when the temperature increased, thereby indicating endothermic vaporization of the resist, and a second weight loss shows generation of heat during the depositing of metal catalysts and removing ligands with the thermal decomposition of the metal precursors. Accordingly, when forming the catalytic resist in this embodiment of the present invention, metal catalyst particles should be deposited by the thermal decomposition of the metal precursors to obtain a high exothermic peak generally corresponding to the second weight loss.

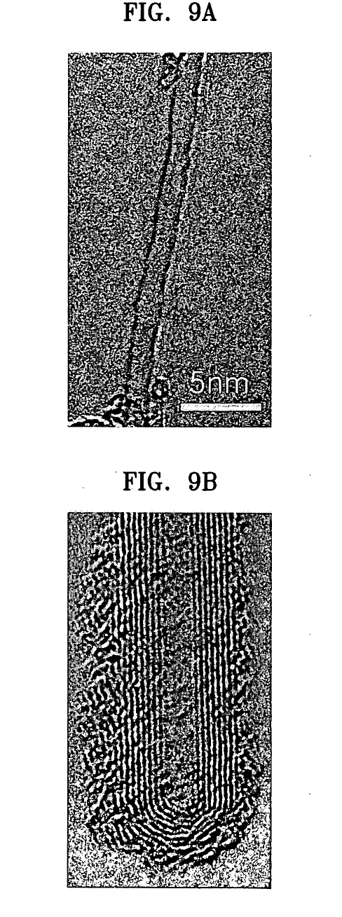

FIGS. 9A and 9B are transmission electron microscope (TEM) images showing superior singlewall CNTs and multiwall CNTs formed when utilizing the catalytic resist having a metal precursor compound according to an embodiment of the present invention.

According to the present invention, the use of a catalytic resist having a metal precursor compound enables the deposition of superior catalyst particles at selected sites, to thereby site-selectively perform subsequent processes using the catalyst particles. In addition, the use of the catalytic resist according to the present invention makes it possible to consecutively perform a patterning process for catalyst particles and thereby simplifies the process.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A catalytic resist comprising:
a resist; and
a metal precursor compound uniformly dispersed in the resist.

2. The catalytic resist of claim 1, wherein the metal precursor compound is an organic metal compound chemically unreactive with the resist and insoluble in water.

3. The catalytic resist of claim 2, wherein the organic metal compound comprises at least one metal selected from the group consisting of Fe, Co, Cu, Ni, Cr, Mo, Pt, Pd, Rh, Au and Ag.

4. The catalytic resist of claim 1, wherein the resist comprises a photoresist and an electron beam resist.

5. The catalytic resist of claim 4, wherein the photoresist comprises photoactive compounds, a polymer resin and a solvent.

6. The catalytic resist of claim 4, wherein the electron beam resist comprises a polymer and a solvent.

7. The catalytic resist of claim 6, wherein the polymer comprises polymethyl methacrylate (PMMA).

8. A method of patterning catalyst particles comprising:
applying a catalytic resist having a resist and a metal precursor compound uniformly dispersed in the resist on a substrate;
forming a catalytic resist pattern by patterning the catalytic resist in a predetermined shape; and
depositing catalyst particles at predetermined sites by removing organic substances from the catalytic resist pattern.

9. The method of claim 8, wherein a predetermined substance layer is formed on the surface of the substrate.

10. The method of claim 9, wherein the substrate is made of silicon and the substance layer is made of silicon oxide (SiO₂).

11. The method of claim 9, wherein the method further comprises etching the substance layer at a predetermined depth by using the catalytic resist pattern as an etching mask after forming the catalytic resist pattern.

12. The method of claim 8, wherein the metal precursor compound is an organic metal compound chemically unreactive with the resist and insoluble in water.

13. The method of claim 12, wherein the organic metal compound comprises at least one metal selected from the group consisting of Fe, Co, Cu, Ni, Cr, Mo, Pt, Pd, Rh, Au and Ag.

14. The method of claim 8, wherein the resist comprises a photoresist and an electron beam resist.

15. The method of claim 14, wherein the photoresist comprises photoactive compounds, a polymer resin and a solvent.

16. The method of claim 14, wherein the electron beam resist comprises a polymer and a solvent.

17. The method of claim 16, wherein the polymer comprises polymethyl methacrylate (PMMA).

18. The method of claim 8, wherein the catalytic resist is applied on the substrate by a spin coating method.

19. The method of claim 8, wherein the patterning of the catalytic resist comprises:
exposing the catalytic resist applied on the substrate by using a mask having a predetermined pattern; and
developing the catalytic resist exposed in a predetermined pattern.

20. The method of claim 8, wherein the catalyst particles are deposited by burning or plasma ashing the catalytic resist pattern under an oxidizing atmosphere.
